(19) United States
(12) Patent Application Publication
(10) Pub. No.: US 2023/0360061 A1
(43) Pub. Date: Nov. 9, 2023

(54) DIGITAL ENVIRONMENTAL CLAIMS ECOSYSTEM FOR PHYSICAL COMMODITY ASSETS

(71) Applicant: Fiutur Information Exchange Inc., New York, NY (US)

(72) Inventors: Joseph James Madden, Santa Cruz, CA (US); Jeff Cohen, Larkspur, CA (US); David Cameron Prell, McLean, VA (US); Paul Sestili, Rancho Mirage, CA (US); Ananda Mohan Bose, New York, NY (US); Andrew John Pisano, New Rochelle, NY (US); Samuel Joseph Teplitsky, Bainbridge Island, WA (US); David Browne, Seattle, WA (US); Michael Patrick DiPetrillo, Port Orange, FL (US)

(21) Appl. No.: 18/143,889

(22) Filed: May 5, 2023

Related U.S. Application Data
(60) Provisional application No. 63/338,492, filed on May 5, 2022.

(51) Int. Cl. G06Q 30/018

(52) U.S. Cl. CPC G06Q 30/018; G06Q 2220/00

(57) ABSTRACT

Systems and methods for generating digital assets corresponding to physical commodities are provided. Attributes identifying a first physical commodity are used to determine environmental attributes of the first physical commodity. Based on the first physical commodity and the environmental attributes, one or more smart contracts are contacted and activated to generate digital assets. The attributes and an indication of the digital asset are used in conjunction with the smart contract to generate a correlated digital asset, which can be recorded on a digital ledger.

### CROSS-REFERENCE TO RELATED APPLICATION(S)

This application claims the benefit of and priority to U.S. Provisional Application No. 63/338,492, filed on May 5, 2022, entitled “DIGITAL ENVIRONMENTAL CLAIMS ECOSYSTEM FOR PHYSICAL COMMODITY ASSETS,” which is hereby incorporated by reference herein in its entirety.

### TECHNICAL FIELD

The following disclosure is directed to methods and systems for generating and tracking digital assets and, more specifically, methods and systems for generating and tracking digital assets associated with physical and environmental commodities.

### BACKGROUND

Tracking of physical and environmental commodity supply chains has become an increasingly essential component of corporate sustainability and climate action efforts, where the carbon intensity and other environmental impacts of billions of units of physical commodity assets (e.g., barrels of oil, sustainable aviation fuel) needs to be identified, measured, rendered transparent, and priced into the marketplace. To substantiate and audit the measurement and value of such environmental claims, digital networks and infrastructure for the collection, refinement, and packaging of decision-useful data are necessary at every step in a commodity's lifecycle—i.e., for each unit and type of physical commodity in commerce. Such information has been historically difficult to acquire, and more difficult to compile, process, refine, and package into a usable payload. Accordingly, systems and methods are needed to (1) access, convert, translate, structure, and store data associated with physical commodities, (2) facilitate the digitization and standard classification of such refined data as a nonfinancial intangible asset, (3) enable the transfer and conveyance of ownership in such digital environmental claims, and (4) promote the investment in and other value(s) propositions associated with specified environmental claims between participants.

### SUMMARY

The methods and systems described herein provide a novel and unique approach for structuring and translating environmental, social, and governance (ESG) data associated with physical commodities into fully auditable, physically-settled, non-fungible and fungible digital assets (hereinafter “digital ESG assets”) that represent the transfer of rights in the defined value associated with specified environmental claims. A multi-layered governance system (referred to herein as a “Standard Market Asset and Registry Transaction (SMART) system”) can include data standards, standard attribute ontologies and environmental asset specifications, standard digital ESG asset templates, and multi-tier interoperable networks of processing nodes and automated smart contracts for claims management. Use of a decentralized computing network built on such a network enables seamless interactions among otherwise unaffiliated stakeholders across physical commodity value chains using an innovative governance system to ensure market and data integrity. Participants can source, configure, authenticate, and register qualifying data as standard digital ESG assets that each represent, convey, and substantiate the environmental claims associated with a physical commodity that generate such data as discrete environmental attributes and impacts.

The SMART system establishes standard rules including atomic data models and refining procedures for physical commodities. Such atomic data models and refining procedures (i) utilize a common data schema and a set of configuration templates for a dynamic taxonomy of environmental claims (e.g., types of physical commodities and performance values for the types) governed under common market rules and procedures; (ii) subject unrefined data to automated computer processes and functions to ingest, refine, authenticate, and verify that such data is accurately captured and correlated to defined environmental claims, thereby producing a refined data payload; and (iii) for each refined data payload stored, generate a non-fungible digital asset that can be custodied, managed, transacted, and/or retired across an interoperable network of qualifying digital registries. Thus, an end-to-end SMART system is disclosed herein for the immutable conversion of data into a registered environmental asset that can be traced across supply chain lifecycles and relied upon by parties associated with the supply chain lifecycle.

The methods described herein and referred to herein generally as a Standard Market Asset and Registry Transaction (SMART) protocol enable interoperable computer interfaces to execute a self-regulated set of smart contracts for: (i) collection of specific unrefined data, (ii) processing and verification of collected information through standard environmental attribute algorithms, and (iii) generation of standard digital ESG assets across authorized registries.

One embodiment of the SMART protocol described herein uses an network governance model to provide smart contract templates for both “proof of state” data authentication and the minting/generation of standardized digital ESG assets that can then be transferred across an interoperable market network. For example, a standard smart contract may enable carbon intensity data to be collected and authenticated by a qualified data aggregation computer node using a first smart contract, which processes multiple layers of specified data associated with production and/or creation of a physical commodity (e.g., natural gas, oil, etc.). The data aggregation node may then employ a second smart contract to measure and verify the carbon intensity of the physical commodity according to one or more third-party standards and methodologies. The data aggregation node may then interface with a standards body or other third-party computer to validate a refined data payload and authorize a third smart contract to generate a digital ESG asset including the refined data payload in an authorized registry system. When smart contracts at each step in the SMART protocol are executed, the standardized interfaces across decentralized computing networks may be activated for generating, transferring, using, and recording/auditing both the refined data payload and the resulting digital ESG assets. The system (e.g., closed-loop system) generates (i) a portfolio of digital ESG assets that can be transacted, and (ii) a “proof of state” audit trail that provides a traceable guarantee of data substantiation and environmental claim origin, all in accordance with governance control logic ensuring the integrity and end-to-end credibility of certified environmental claims and data artifacts.

The SMART protocol establishes a set of attribute templates, asset configurations, and standard computer interfaces that execute system processes for the decentralized configuration, generation, custody, and management of multiple attribute-based or ESG-related digital asset types (e.g., representing both fungible and/or non-fungible assets for environmental claims). The criteria per asset class and type can be dependent on a set of attribute specifications and methodologies for relational database interfaces, substantiated by data which is refined and verified over a distributed computing network from a remote computing node and to provide environmental claim registration and “proof of state” data authentication back to source information.

The SMART system implementing the SMART protocol may enable distributed users to refine substantiating data and package attribute payloads within a particular physical or environmental commodity classification system on an approved/authorized registry database (e.g., distributed digital ledger or other cloud-based database meeting ecosystem criteria). Such classified payloads may be registered as assets with an automated and unique owner identifier (ID) code indicative of the applicable attribute class.

In one primary example, the SMART system may be used to generate and/or otherwise mint digital ESG assets that include the environmental attributes associated with the physical commodities (e.g., oil, gas, soy, corn). The digital ESG assets thus operate as a digitized model of the physical commodity inclusive of the physical commodity's environmental impacts and characteristics. In some cases, the digital ESG assets may be updated and merged with other digital ESG assets on a network of the SMART system when (i) the encoded attributes are changed or updated during (e.g., throughout) the lifecycle of that physical commodity, or (ii) when a correlated digital ESG asset is derived by correlating the digitized attributes or performance values of more than one physical commodity unit or more than one set of activities in commerce. That is, a change in the environmental impact and/or characteristics of a physical commodity across its supply chain can be mirrored by a change in the digital ESG asset (also referred to as a “digital twin”) that corresponds to the physical commodity. Such a change in the primary digital ESG asset may then also be dynamically compared and correlated to other market benchmarks based on the numeric values and/or environmental attribute performance values themselves. For example, when crude oil is first extracted from a well, the crude oil may be put into a barrel. The barrel of oil may then be shipped to a refinery where the oil may be refined, and the refined contents may be put into a cistern or another suitable container to be delivered to a particular destination. This process may be mirrored by generating a digital representation of the raw materials that includes the raw materials' environmental attributes and/or claim (e.g., including the impact of how that barrel of oil was produced, transported, etc.). Furthermore, intermediate or “nodal” digital assets may be generated or appended to the initial digital asset along its supply chain. Alternatively, or in addition, the system may be limited to the processing and refining of data substantiating environmental attributes (e.g., clean energy production credits) based on how a physical commodity is produced, exclusive of the physical commodity's raw material.

The SMART system may determine, based on the processing of unrefined data into defined sets of standard environmental attributes, both the type and genus of a corresponding digital ESG asset, as attributable to, or correlated from, the underlying physical commodity. The digital ESG asset registering those attributes may include one or more environmental claims regarding that physical commodity (e.g., oil) and its production based on its refined and auditable information.

The SMART protocol can initially be understood as a system to capture, collect, and process a specific plurality of data points indicating the first physical commodity and its environmental attributes/claim to enable production of a refined data payload of environmental attributes. The data points can be input to a first smart contract to produce the refined data payload of environmental attributes. The refined data payload of environmental attributes can be input to a second smart contract to (i) classify, certify, and verify an environmental claim of the first physical commodity as measured against a third party environmental performance standard or set of criteria, and (ii) interface with third party verification nodes in a network to issue a digital certificate (e.g., a digital carbon intensity certificate) derived from the primary digital ESG asset and associated with the achieved environmental performance substantiated by its corresponding data payload. A performance standard as described herein may include one or more empirical or correlating algorithms used to quantify a genotypic (e.g., inherent) or phenotypic (e.g., expressed) value for the performance standard based on values of environmental attributes used as inputs to the empirical or correlating algorithms. The empirical or correlating algorithms may measure and/or otherwise quantify environmental performance of a physical commodity based on the values of the environmental attributes for the physical commodity. In some cases, the empirical or correlating algorithms may be formulated based on environmental performance standards (e.g., third-party, open source environmental performance standards).

When a primary digital ESG asset containing a digital representation of the first physical commodity (e.g., including its defined environmental attributes and impacts) is mapped at the data aggregation and refinement node, the SMART system may record the refined data payload onto an electronic ledger (e.g., distributed digital ledger including a network of computing nodes) that can be audited and transparently verified, thereby generating and registering a primary digital ESG asset representing the first physical commodity and its environmental attributes and characteristics. For example, the SMART system may record the refined data payload of environmental attributes onto a blockchain network of distributed processing nodes or another suitable electronic ledger, provided such ledger meets both security and interoperability criteria.

The SMART system may then link and/or correlate the primary digital ESG asset of the first physical commodity to (i) secondary digital ESG assets (e.g., digital ESG assets derived for the first physical commodity from the primary digital ESG asset information at later stages in a supply chain lifecycle of the first physical commodity and/or for an environmental claim of the first physical commodity) and/or (ii) primary or secondary digital ESG assets tied to other types of physical commodities. Such correlation may indicate the linked or correlated relationships between digital ESG assets on an electronic ledger (e.g., accessible to the market via transparent market operations). In some embodiments, the SMART system may mark, on the electronic ledger, the primary digital ESG asset as the component of the secondary digital ESG asset. The marking may disable or encumber transfer of the primary digital ESG asset without the secondary digital ESG asset.

In various aspects, embodiments of the present disclosure feature a computer-implemented method and supporting systems. In one aspect, the subject matter described herein relates to a computer-implemented method for generating digital assets corresponding to physical commodities. The method can include receiving a first plurality of attributes identifying a first physical commodity. The method can include determining, based on the first plurality of attributes, one or more environmental attributes of the first physical commodity. The method can include determining, based on at least one of the one or more environmental attributes, a performance type for the first physical commodity and a performance value for the performance type, where the performance type is selected from a plurality of performance types. The method can include identifying, based on a type of the first physical commodity and the one or more environmental attributes, one or more smart contracts configured to (i) generate a first digital asset identifying the first physical commodity, and (ii) generate a correlated digital asset associated with the first digital asset, where the one or more smart contracts are selected from a plurality of smart contracts. The method can include providing the first plurality of attributes identifying the first physical commodity and the one or more environmental attributes to the one or more smart contracts to generate the first digital asset, where the first digital asset includes (i) a unique identifier for the first physical commodity, (ii) the first plurality of attributes, and (iii) the one or more environmental attributes. The method can include providing the first plurality of attributes identifying the first physical commodity and an indication of the first digital asset to the one or more smart contracts to generate the correlated digital asset, wherein the correlated digital asset includes (i) an indicator of an association of the correlated digital asset to the first digital asset, (ii) the performance type for the first physical commodity, and (iii) the performance value for the performance type. The method can include causing recordation of the first digital asset and the correlated digital asset on a digital ledger.

Various embodiments of the method can include one or more of the following features. In some cases, the first plurality of attributes are derived from production of the first physical commodity. In some cases, the first physical commodity includes one of: oil, natural gas, corn, or soy. In some cases, the one or more environmental attributes of the first physical commodity include one or more of: carbon content, water usage, or methane content. The determining the one or more environmental attributes can further include: providing the first plurality of attributes to the one or more smart contracts, where the one or more smart contracts are configured to determine the one or more environmental attributes from the first plurality of attributes. The determining the performance type for the first physical commodity and the performance value for the performance type can further include providing the at least one of the one or more environmental attributes to the one or more smart contracts, where the one or more smart contracts are configured to measure the performance value for the performance type based on comparing a value of the at least one of the one or more environmental attributes to an environmental performance standard or methodology including one or more algorithms.

In some cases, the performance type of the first physical commodity includes one of: a carbon content intensity or a natural gas intensity. An environmental claim for the first physical commodity can include (i) the performance type for the first physical commodity and (ii) the performance value for the performance type. In some cases, the environmental claim for the first physical commodity is correlated to the at least one of the one or more environmental attributes by one or more algorithms, where the correlated digital asset comprises an indication of the one or more algorithms. In some cases, the first digital asset and the correlated digital asset each include a non-fungible token. The method can further include receiving a second plurality of attributes identifying a second physical commodity, where the second physical commodity is dependent on the first physical commodity. The method can further include identifying one or more second smart contracts configured to generate a second digital asset identifying the second physical commodity, where the one or more second smart contracts are selected from the plurality of smart contracts. The method can further include providing the second plurality of attributes identifying the second physical commodity and the indication of the first digital asset to the one or more second smart contracts to generate the second digital asset, where the second digital asset comprises an indicator of an association of the second digital asset to the first digital asset and the second plurality of attributes. The method can further include causing recordation of the second digital asset on the digital ledger.

In some cases, the method can further include determining, based on the second plurality of attributes, one or more second environmental attributes of the second physical commodity, where the second digital asset comprises the one or more second environmental attributes. The method can further include causing recordation of a digital marking on the digital ledger, where the digital marking indicates an association between the first digital asset and the second digital asset. The digital marking can be configured to require a first digital wallet address to own both the first digital asset and the second digital asset. The digital marking can be configured to require bundled transfer of the first digital asset and the second digital asset from a first digital wallet address to a second digital wallet address. In some cases, the second physical commodity being dependent on the first physical commodity can further include the second physical commodity being derived from the first physical commodity. In some cases, the digital ledger can be implemented as a network of decentralized independent processing nodes.

Other aspects of the present disclosure comprise systems implemented in various combinations of computing hardware and software to achieve the methods described herein.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present embodiments. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present disclosure.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 illustrates an example computing environment for physical commodity data collection and refinement and digital asset generation, in accordance with some embodiments of this disclosure.

FIG. 2 shows an example flowchart of a method for generating a first and second digital assets for first and second physical commodities, respectively, in accordance with some embodiments of this disclosure.

FIG. 3 shows an example flowchart of a method for generating a first digital asset and a correlated digital asset for a first physical commodity, in accordance with some embodiments of this disclosure.

FIG. 4 shows an example computing system that may be used in accordance with some embodiments of this disclosure.

### DETAILED DESCRIPTION

In the following description, for the purposes of explanation, numerous specific details are set forth in order to provide a thorough understanding of the disclosure. It will be appreciated, however, by those having skill in the art, that the disclosure may be practiced without these specific details or with an equivalent arrangement. In other cases, well-known structures and devices are shown in block diagram form to avoid unnecessarily obscuring the disclosure.

A SMART protocol and supporting systems may be used to perform the operations described in this disclosure via a decentralized computing system. The SMART protocol may rely on a computing system that is operatively connected to one or more network communications devices and an authorized data refinement node and/or digital ESG asset registry (e.g., for refining data into attributes and onboarding digital assets). Some aspects of the digital ESG asset refining, configuration, and validation pathway may include control logic for processing data, as well as minting, intermingling, and exchanging assets meeting proof of state authentication. As an example, a decentralized computing system is disclosed for automating the generation of cryptographic digital assets associated with production of physical commodities (e.g., natural gas commodities). The decentralized computing system can include a network of interfaces and communications devices that connects with one or more remote computing nodes over a distributed computing network, and an authorized or eligible digital asset registry.

Each primary digital ESG asset may include specific attributes classified and sub-classified in accordance with standardized governance and control logic. The data schema included in the primary digital ESG asset may be interoperable with various computer networks. Furthermore, the data schema may have a plurality of attributes (e.g., genotypic or phenotypic traits) that are at least partially linked to or derived from a string (e.g., encrypted and/or alphanumeric string) of source information corresponding to (e.g., indicative of) the underlying first physical commodity. In this sense, the string may be akin to the genetic code of the digital asset and may enable end-to-end authentication of environmental claims. During the distributed generation of the digital asset, an automated smart contract may also authenticate an origin and ownership of the data and corresponding specific attributes, then track future transactions of primary and secondary ESG assets back to source data of the specified attributes. Each digital ESG asset may therefore be linked to each of its encoded attributes and the audit trail of its refined data payloads. After generation and using a common set of market rules and standardized digital ESG assets, a stakeholder may (i) transfer digital ESG assets to other parties through a set of standard market tier smart contracts, and/or (ii) manage and retire digital ESG assets in with assurance of environmental claims associated therewith.

The disclosed SMART system may support tracking, monitoring, and auditing of environmental claims across computer networks and/or in concert with corporate management software. Registered and immutable digital ESG assets generated for environment claims can enable harvesting of the real and perceived economic value of the environment claims. For example, digital assets for environmental claims can capture the economic value of the environmental claims in both market trading contexts and the context of connecting the refined payload datasets substantiating the primary digital ESG asset's attributes to the first physical commodity and/or a secondary digital ESG asset. In such a context, the first physical commodity and/or secondary digital ESG asset can be critical to the retiring, reporting, and disclosing of credible environmental claims and holdings to third-parties (e.g., regulators, supply chain participants, banks, and the public). In some cases, the SMART system may be capable of generating digital ESG assets and interfacing with environmental (e.g., carbon or climate risk) accounting servers to update and/or manage climate-related corporate disclosures. In some instances, smart contracts may implement all of the recordkeeping and trace guarantee functions in an approved registry to process accounting.

The methods and related systems disclosed herein provide for significant improvements in generating and tracking digital assets indicative of data associated with physical and environmental commodities by providing transparent, auditable information to participants. The methods and related systems disclosed herein constitute specific implementations of solutions to problems that arise when attempting to track, transact, audit, and retire data corresponding to physical commodities and their related attributes (e.g., environmental claims and/or environmental attributes). Thus, the improved generation and tracking techniques for digital assets corresponding to physical commodities described herein constitute improvements to computer-related technology, and specifically the way the computer stores and retrieves data in memory in combination with the specific data structure.

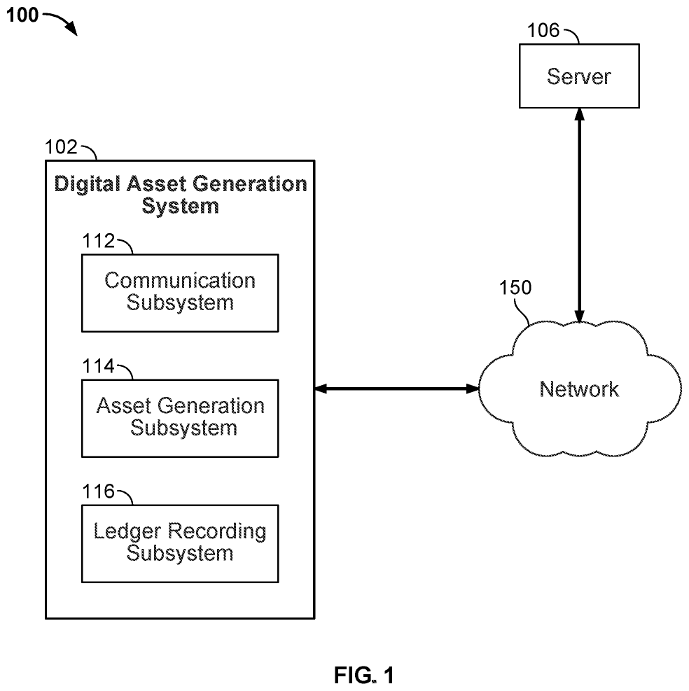

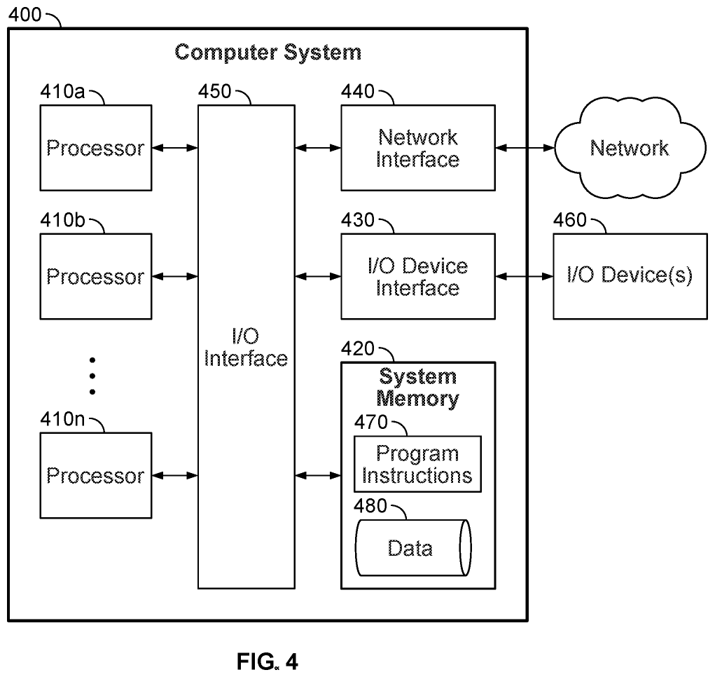

FIG. 1 shows an example computing system 100 (also referred to as a SMART system 100) for implementing a SMART protocol. The SMART system 100 may include a digital asset generation system 102 and a server system 106. The digital asset generation system 102 may execute instructions for generation of digital assets (e.g., digital ESG assets) and other asset lifecycle events (e.g., transfer of ownership) through to retirement of the digital assets. Processes performed by the digital asset generation system 102 for data processing, digital ESG asset generation, through to retirement may be implemented via software, hardware, or a combination of the two. For example, the digital asset generation system 102 may be a physical computing device or a virtual computing that is running on a physical computer system. The digital asset generation system 102 may be a server system, a virtual server, a personal computer, a smart phone, a laptop computing device, an electronic tablet, or another suitable user device. The digital asset generation system 102 may include a communication subsystem 112, an asset generation subsystem 114, and/or a ledger recording subsystem 116. In some cases, the digital asset generation system 102 may include other components (e.g., as described with respect to FIG. 4).

In some embodiments, the communication subsystem 112 may include software components, hardware components, or a combination of both. For example, the communication subsystem 112 may include a network card (e.g., a wireless network card and/or a wired network card) that is coupled with software to drive the card. In some cases. The asset generation subsystem 114 may include software components, hardware components, or a combination of both. For example, the asset generation subsystem 114 may include software components that access data in memory and/or storage, and may use one or more processors to perform its operations. In some cases, the ledger recording subsystem 116 may include software components, hardware components, or a combination of both. For example, the ledger recording subsystem 116 may include software components that access data in memory and/or storage, and may use one or more processors to record data (e.g., blocks) onto an electronic ledger (e.g., blockchain network of distributed processing nodes). In some embodiments, ledger recording subsystem 116 may perform functions of a processing node of a blockchain network.

In some embodiments, the server system 106 may host various applications that have server components. In some embodiments, the server system 106 may host an electronic ledger (e.g., be a node on a blockchain network). In some embodiments, the server system 106 may host one or more smart contracts and or other data (e.g., template/workflow data). The server system 106 may include software, hardware, or a combination of the two. For example, the server system 106 may be a physical server, or a virtual server that is running on a physical computer system. In some cases, a network 150 may communicatively connect the digital asset generation system 102 and the server system 106. The network 150 may be a local area network, a wide area network (e.g., the Internet), or a combination of the two.

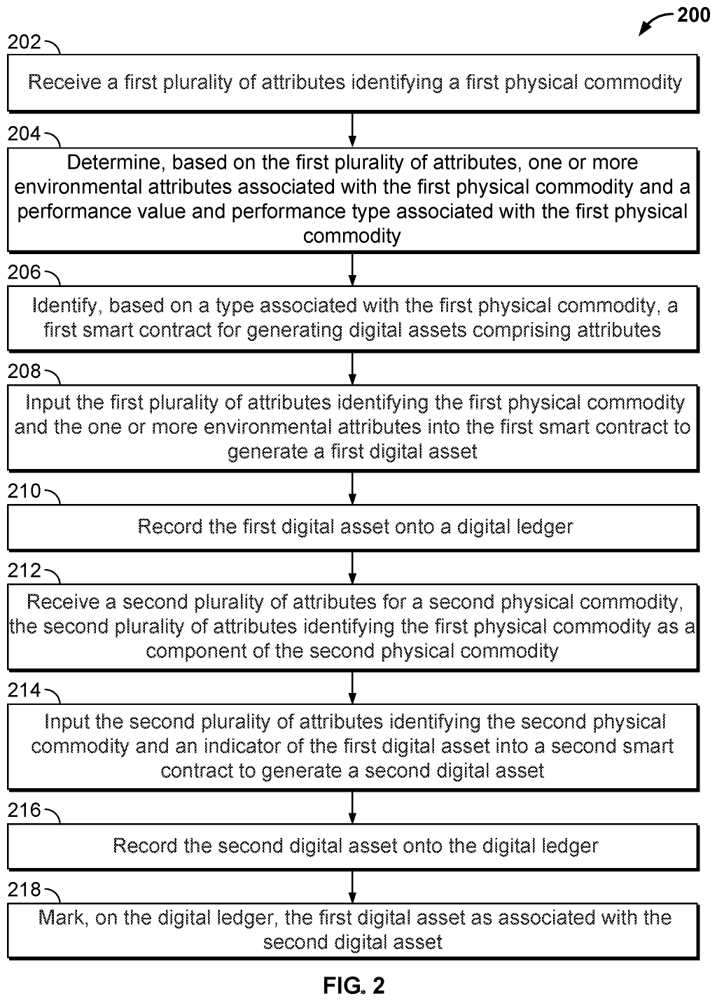

FIG. 2 shows a flowchart for a method 200 executed by a SMART system (e.g., SMART system 100). The method 200 may include steps for generating a first digital asset (e.g., primary digital ESG asset), a correlated digital asset of the first digital asset, and/or a second digital asset (e.g., secondary digital ESG asset). The method 200 may be performed using the digital asset generation system 102 (e.g., including the subsystems of the digital asset generation system 102).

In some embodiments, execution of the method 200 by the SMART system may cause generation of first and second digital assets corresponding to first and second physical commodities, respectively. In some case, a first plurality of attributes may identify the first physical commodity and a second plurality of attributes may identify the second physical commodity Based on the values and/or indicators included the first plurality of attributes and second plurality of attributes, a performance type and/or values of a plurality of environmental attributes may be determined for the first physical commodity and the second physical commodity respectively. Digital assets may be generated and recorded on an electronic ledger (e.g., digital ledger including a network of distributed processing nodes), where the digital assets may include indications of (i) unique identifiers to uniquely identify the physical commodities, (ii) performance values for performance types, (iii) and/or values of a plurality of environmental attributes. Digital assets may be linked to indicate dependencies between digital assets and markings of such linkages may be recorded on the electronic ledger. In some cases, a separate digital asset (referred to as a “correlated digital asset”) may be generated that includes a verified value of a performance type corresponding to a performance standard (e.g., third-party performance standard, framework, or methodology) for the first physical commodity, which may be derived by measuring the first physical commodity's environmental attributes against the performance standard and which may be linked to the first digital asset (e.g., primary digital ESG asset). Values for performance types and attributes (e.g., including environmental attributes) as described herein may be quantitative or qualitative (e.g., categorical) values. A digital ledger as described herein may include a network (e.g., blockchain network) of distributed processing nodes).

At step 202, the digital asset generation system 102 may receive (e.g., using the communication subsystem 112) a data payload of a first plurality of attributes identifying a first physical commodity. For example, the digital asset generation system 102 may receive the attributes from the server system 106. As discussed above, the attributes may be associated with creation and/or production of the first physical commodity (e.g., extracting oil or natural gas from a well, growing and harvesting corn, raising and processing livestock, etc.). The attributes may be generated using data received from equipment (e.g., meters, sensors, and/or other indicators) that are used as a part of a production process for the first physical commodity (e.g., sensors determining sulfur content in oil). In some cases, the attributes may include identifying information for the first physical commodity, including a date and/or time at which the first physical commodity was created or produced, a location where the first physical commodity was created or produced, and/or an entity associated with (e.g., owning or managing) a manufacturing or production facility where the first physical commodity was created or produced. In some cases, the attributes may be input to one or more empirical or correlating algorithms that can measure and/or otherwise quantify environmental performance of the first physical commodity based on the values of the attributes for the first physical commodity.

At step 204, the digital asset generation system 102 (e.g., using the asset generation subsystem 114) may determine (e.g., generate), based on the first plurality of attributes (e.g., received in step 202), a refined data payload including values (e.g., performance values and/or numeric values) and types of one or more environmental attributes of the first physical commodity by applying one or more smart contracts configured to refine the data payload and included attributes. The values of the environmental attributes may be based on the data payload and values of the included attributes. The types of the environmental attributes may be determined based on a type of the physical commodity. In some cases, generating the refined data payload may include inputting the data payload and included attributes into one or more smart contracts, where the one or more smart contracts authenticate and verify that the data payload and included attributes is accurately captured and correlated to defined types of environmental attributes and/or claims corresponding to the first physical commodity. In some cases, the determined values and types of the environmental attributes of the first physical commodity may be selected from a number of types that are organized based on an ontology of types of physical commodities (e.g., oil, gas, corn, soy, grain, livestock, etc.), environmental attributes (e.g., carbon content, water usage, methane content, etc.), and environmental claims (e.g., carbon neutrality, greenhouse gas emissions, waste output, pollutants output, hazardous waste output, etc.).

In some cases, with respect to step 204, the digital asset generation system 102 may determine, based on the determined values and types of environmental attributes of the first physical commodity, a performance type associated with the first physical commodity and a performance value for the respective performance type of the first physical commodity. A performance type associated with a physical commodity and a performance value for the respective performance type of the physical commodity may constitute an “environmental claim” for a physical commodity. For example, the digital ESG asset generation system 102 (e.g., via the asset generation subsystem 114) may determine a methane gas performance value based on a carbon content environmental attribute for the first physical commodity, where in the methane gas performance value is measured based on a comparison of the carbon content of the first physical commodity to a methane gas performance standard. In some cases, the digital asset generation system 102 may determine more than one performance type and value for the first physical commodity. In some cases, determining the performance value and type may include inputting the determined environmental attributes and values for the first physical commodity into one or more smart contracts (e.g., described with respect to step 208), where the one or more smart contracts can validate the determined values of the environmental attributes to determine the performance value in accordance with one or more third-party performance standards, frameworks, and/or methodologies using one or more empirical and/or correlating algorithms. In some embodiments, the measured value of the performance type for the first physical commodity may be included in a correlated digital asset associated with (e.g., linked to) a first digital asset (e.g., primary digital ESG asset) for the first physical commodity. The digital asset generation system 102 may generate (e.g., using the generation subsystem 114) a correlated digital asset (e.g., digital certificate or token) including the performance value for the first physical commodity using a smart contract and one or more environmental attributes of the first physical commodity as described herein (e.g., with respect to step 208). For example, the digital asset generation system 102 may generate a correlated digital asset associated with the first physical commodity indicating the performance value and type of the first physical commodity (e.g., carbon content intensity). In some cases, the performance type and value for the first physical commodity derived from values of the environmental attributes may be compared to a respective performance type and value derived from the first plurality of attributes, thereby providing a comparison between unrefined and refined (e.g., verified) performance values for the same physical commodity.

At step 206, the digital asset generation system 102 may identify (e.g., via the asset generation subsystem 114), based on a type of the first physical commodity (e.g., whether the physical commodity is oil, natural gas, soy, corn, etc.) and/or types of the environmental attributes of the first physical commodity, a first smart contract for refining and generating digital ESG assets including indications of the environmental attributes of the first physical commodity. For example, the system may store locally or remotely (e.g., on the server system 106) a multitude of smart contracts for a multitude of different types of physical commodities (e.g., for units of gas, units of oil, etc.) and types of environmental attributes. The smart contracts may be organized based on the ontology of physical commodities, environmental attributes, and environmental claims described herein. Thus, the digital asset generation system 102 may identify (e.g., automatically identify) the first smart contract corresponding to the type of the first physical commodity, the environmental attributes of the first physical commodity, and/or the performance or numeric values of the environmental attributes. In some cases, the first smart contract may correspond to the performance value and type for the first physical commodity.

At step 208, the digital asset generation system 102 may input the first plurality of attributes identifying the first physical commodity and/or the environmental attributes of the first physical commodity into the first smart contract (e.g., identified in step 206) to generate a first digital asset (e.g., primary digital ESG asset). For example, the first smart contract may generate, based on the first plurality of attributes of the first physical commodity, (i) a non-fungible token (NFT), or (ii) a standardized set of data components, where the generated token or set of data components includes the refined data payload including the environmental attributes of the first physical commodity. In some embodiments, the generated first digital asset (e.g., primary digital ESG asset) may encode the first plurality of attributes and/or the environmental attributes of the first physical commodity as encrypted or non-encrypted data within the first digital asset (e.g., NFT or data components). The refined data payload for the first physical commodity that is included in the first digital asset may be referred to as “parameters” or “parameter data” of the first digital asset. In some cases, a unique ID (e.g., unique string ID) may be added to the refined data payload and included in the parameter data of the first digital asset that uniquely identifies the first physical commodity. In some cases, the first plurality of attributes of the first physical commodity may be included in the refined data payload and included in the first digital asset. In some embodiments, as described herein, the first smart contract may (i) receive the one or more environmental attributes of the first physical commodity and the parameter data of the first digital asset and (ii) use the one or more included environmental attributes and parameter data as an input for generating a correlated digital asset associated with the first digital asset. For example, the first smart contract may generate a correlated digital asset (e.g., an NFT) indicating the environmental attributes and the performance value and type of the first physical commodity, thereby linking or correlating the values for the environmental attributes and the performance value and type included in the correlated digital asset to the first plurality of attributes of the first digital asset (e.g., primary digital ESG asset). In some cases, the correlated digital asset may include an indicator linking the correlated digital asset to the first digital asset. For example, the correlated digital asset may include the unique ID included in the primary digital ESG asset, such that the correlated digital asset verifies an environmental performance standard associated with the first physical commodity identified by the primary digital ESG asset and the included attributes. Accordingly, the correlated digital asset may encode one or more of the environmental attributes from the first digital asset (e.g., primary digital ESG asset) and the performance value and type for the first digital asset, and the one or more empirical or correlating algorithms corresponding to a performance standard that are used to determine the performance value and type based on the values of the environmental attributes.

At step 210, the digital asset generation system 102 may record (e.g., via the ledger recording subsystem 116) and/or send instructions to cause recordation of the first digital asset (e.g., primary digital ESG asset) onto a digital ledger. For example, the digital asset generation system 102 may record the primary digital ESG asset onto a blockchain network of distributed processing nodes or send instructions to a blockchain network of distributed processing nodes to cause recordation of the primary digital ESG asset on the blockchain network. In some cases, the digital asset generation system 102 may record (e.g., via the ledger recording subsystem 116) and/or send instructions to cause recordation of the correlated digital asset associated with the first digital asset onto a digital ledger. For example, the digital asset generation system 102 may record the correlated digital asset onto a blockchain network of distributed processing nodes or send instructions to a blockchain network of distributed processing nodes to cause recordation of the correlated digital asset onto the blockchain.

In some embodiments, the recordings of the first digital asset and the correlated digital asset on the digital ledger may enable a user of the digital ledger to trace the origins of the correlated digital asset through a “proof of state” audit function based on control logic to map the entire lifecycle of the first digital asset (e.g., primary digital ESG asset) back to original source data (e.g., the first plurality of attributes identifying the first physical commodity). As an example, the recordings may enable a user to identify the correlated digital asset and its included attributes and use such attributes to verify the performance value and type of the first physical commodity as indicated by the first digital asset. As another example, the recordings may enable tracking of the performance value for the first digital asset associated with the first physical commodity within a marketplace and/or digital registries. In some cases, the recordings may enable a user to retire the first digital asset (e.g., primary digital ESG asset) and/or the correlated digital asset from use in a marketplace and/or digital registries based on allowing traceable identification of the performance value indicated by the correlated digital asset.

At step 212, the digital asset generation system 102 may receive (e.g., via the communication subsystem 112), a second plurality of attributes identifying a second physical commodity (e.g., having a same or different type than the first physical commodity). As discussed above, the attributes may be attributes associated with creation and/or production of the second physical commodity (e.g., refining oil or natural gas). In some cases, one or more environmental attributes for the second physical commodity may be derived from the second plurality of attributes and verified via input to a smart contract as described herein (e.g., with respect to step 204). The second plurality of attributes may identify the first physical commodity as a component, result, or dependency of the second physical commodity. In some cases, the second plurality of attributes may identify the first physical commodity, the environmental attributes of the first physical commodity, and/or values of the environmental attributes of the first physical commodity as a component, result, or dependency of the second physical commodity, the environmental attributes of the second physical commodity, and/or the values of the environmental attributes of the second physical commodity. For example, the digital asset generation system 102 may receive environmental attributes indicating that a unit of crude oil corresponding to the first digital asset (e.g., primary digital ESG asset) has been refined into a unit of refined oil using refining methods that substantially reduced the production carbon intensity when correlated to a baseline unit of refined oil.

At step 214, the digital asset generation system 102 may input (e.g., via the asset generation subsystem 114) the second plurality of attributes identifying the second physical commodity and an indicator (e.g., parameters and/or unique ID) of the first digital asset (e.g., primary digital ESG asset) into a second smart contract to generate a second digital asset (e.g., secondary digital ESG asset). The second digital asset may include the parameter data of the first digital asset and the second plurality of attributes (e.g., including environmental attributes) encoded as second parameters of the second digital asset. In some embodiments, the second digital asset may include one or more encoded environmental attributes that are based on (e.g., derived from) the second plurality of attributes identifying the second physical commodity. For example, the environmental attributes may be encoded in a second digital asset and linked to the primary digital asset. In those instances, the second smart contract may link the primary and secondary digital assets, and encumber and/or subordinate the transfer or retirement of the first digital asset (e.g., primary digital ESG asset) on the digital ledger to the second digital asset (e.g., secondary digital ESG asset).

At step 216, the digital asset generation system 102 may record (e.g., via the ledger recording subsystem 116) and/or send instructions to cause recordation of the second digital asset (e.g., secondary digital ESG asset) onto the digital ledger. For example, the digital asset generation system 102 may record the secondary digital ESG asset onto a blockchain network of distributed processing nodes or send instructions to a blockchain network of distributed processing nodes to cause recordation of the secondary digital ESG asset on the blockchain network. As part of the recording on the digital ledger, the digital asset generation system 102 may link (e.g., associate, establish a relationship between, etc.) the first digital asset (e.g., primary digital ESG asset) to the second digital asset (e.g., secondary digital ESG asset). Linking the first and second digital assets may include encoding an indicator in the second digital asset that indicates a relationship, association, and/or dependency between the first and second digital assets and underlying first and second physical commodities. For example, linking the first and second digital assets may cause the second digital asset to include an indication that that second physical commodity is a component, result, or dependency of the first physical commodity (e.g., that the second physical commodity was derived from the first physical commodity) corresponding to the first digital asset.

At step 218, the digital asset generation system 102 may mark, on the digital ledger, the first digital asset (e.g., primary digital ESG asset) and/or the environmental attributes indicated by the first digital asset as associated with (e.g., as a component and/or input of) the secondary digital asset (e.g., secondary digital ESG asset). The marking recorded on the digital ledger may be a data structure (e.g., digital certificate or token) indicating of the first digital asset as a component and/or input of the secondary digital asset and the first physical commodity as a component and/or input of the secondary physical commodity. In some cases, the marking may disable transfer of the first digital asset (e.g., primary digital ESG asset) from a first owner to a second owner without the second digital asset (e.g., secondary digital ESG asset), such that the first and second digital assets may not be separately transferred from a first owner to second and third owners, respectively. In some cases, the marking may bundle transfer of the first digital asset (e.g., primary digital ESG asset) with the second digital asset (e.g., secondary digital ESG asset) from a first owner to a second owner, such that the first and second digital assets must be commonly owned by the same owner and may not be individually transferred to different owners. Owners of the digital assets described herein may own and/or otherwise manage digital wallet addresses recording ownership of the digital assets.

In some embodiments, the marking recorded on the digital ledger may enable a user of the digital ledger to trace the origins of the second digital asset (e.g., secondary digital ESG asset) through a “proof of state” audit function based on control logic to map the entire lifecycle of the first digital asset (e.g., primary digital ESG asset) back to original source data (e.g., the first plurality of attributes identifying the first physical commodity). As an example, the marking may enable a user to identify the second physical commodity and its related attributes as indicated by the second digital asset, as well that the derivation of the second physical commodity from the first physical commodity and its related attributes indicated by the first digital asset. As another example, the marking may enable a user to compare or correlate performance values corresponding to the first and second physical commodities identified by the first and second digital assets, respectively, thereby enabling tracking of environmental claims associated with physical commodities within a marketplace and/or digital registries. In some cases, the marking may enable a user to retire the first digital asset (e.g., primary digital ESG asset) from use in a marketplace and/or digital registries based on allowing traceable identification of environmental claims indicated by second digital assets identifying second physical commodities that were derived from the first physical commodity identified by the first digital asset.

In some embodiments, the method 200 may be executed to generate additional digital assets based on the first digital asset, second digital asset, and digital assets generated therefrom. Digital assets generated and recorded on an electronic digital ledger via execution of the method 200 may be custodied, managed, transacted, and/or retired across an interoperable network of qualifying digital registries. In some cases, more than two digital assets may be linked via execution of the method 200, thereby enabling environmental claim registration and “proof of state” data authentication through multiple digital assets back to source information.

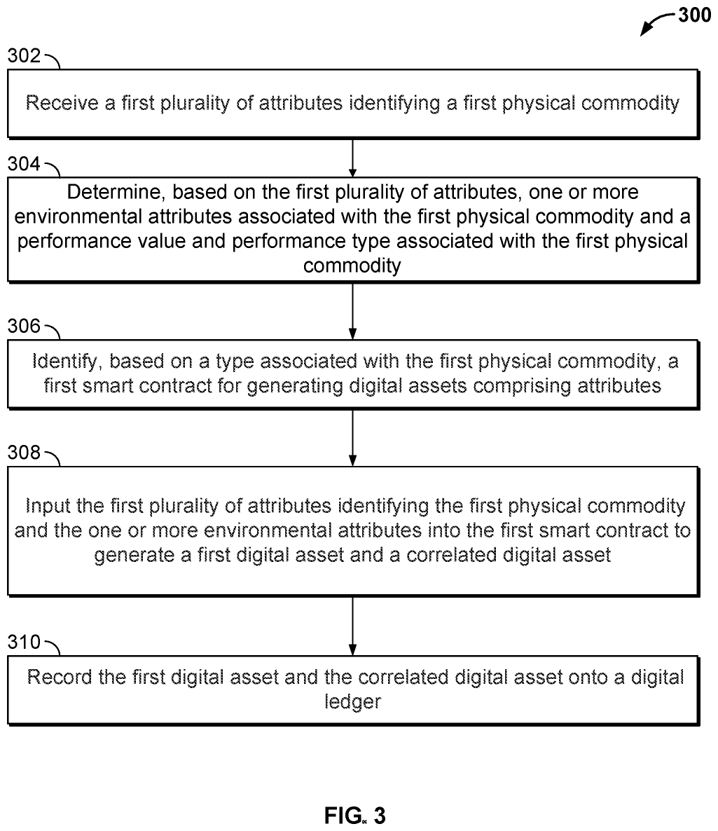

FIG. 3 shows a flowchart for a method 300 executed by a SMART system (e.g., SMART system 100). The method 300 may include steps for generating a first digital asset (e.g., primary digital ESG asset) and/or a correlated digital asset of the first digital asset. The method 300 may be performed using the digital asset generation system 102 (e.g., including the subsystems of digital asset generation system 102).

In some embodiments, execution of the method 300 by the SMART system may cause generation of a first digital asset corresponding to a first physical commodity. In some cases, a first plurality of attributes may identify the first physical commodity. Based on the values and/or indicators included the first plurality of attributes, a performance type and/or values of a plurality of environmental attributes may be determined for the first physical commodity. Digital assets may be generated and recorded on a digital ledger, where the digital assets may include indications of (i) unique identifiers to uniquely identify the physical commodity, (ii) performance values for a performance type, (iii) and/or values of a plurality of environmental attributes. Digital assets may be linked to indicate dependencies between digital assets and markings of such linkages may be recorded on the digital ledger In some cases, a separate digital asset (referred to as a “correlated digital asset”) may be generated that includes a verified value of a performance type corresponding to a performance standard (e.g., third-party performance standard or framework) for the first physical commodity, which may be derived by measuring the first physical commodity's environmental attributes against the performance standard and which may be linked to the first digital asset (e.g., primary digital ESG asset). Values for performance types and attributes (e.g., including environmental attributes) as described herein may be quantitative or qualitative (e.g., categorical) values.

At step 302, the digital asset generation system 102 may receive (e.g., using the communication subsystem 112) a data payload of a first plurality of attributes identifying a first physical commodity. For example, the digital asset generation system 102 may receive the attributes from the server system 106. As discussed above, the attributes may be associated with creation and/or production of the first physical commodity (e.g., extracting oil or natural gas from a well, growing and harvesting corn, raising and processing livestock, etc.). The attributes may be generated using data received from equipment (e.g., meters, sensors, and/or other indicators) that are used as a part of a production process for the first physical commodity (e.g., satellite sensors determining methane emissions leakage from natural gas production well). In some cases, the attributes may include identifying information for the first physical commodity, including a date and/or time at which the first physical commodity was created or produced, a location where the first physical commodity was created or produced, and/or an entity associated with (e.g., owning or managing) a manufacturing or production facility where the first physical commodity was created or produced. In some cases, the attributes may be input to one or more empirical or correlating algorithms that can measure and/or otherwise quantify environmental performance of the first physical commodity based on the values of the attributes for the first physical commodity.

At step 304, the digital asset generation system 102 (e.g., using the asset generation subsystem 114) may determine (e.g., generate), based on the first plurality of attributes (e.g., received in step 302), a refined data payload including values (e.g., performance values and/or numeric values) and types of one or more environmental attributes of the first physical commodity by applying one or more smart contracts configured to refine the data payload and included attributes. The values of the environmental attributes may be based on the data payload and values of the included attributes. The types of the environmental attributes may be determined based on a type of the physical commodity. In some cases, generating the refined data payload may include inputting the data payload and included attributes into one or more smart contracts, where the one or more smart contracts authenticate and verify that the data payload and included attributes is accurately captured and correlated to defined types of environmental attributes and/or claims corresponding to the first physical commodity. In some cases, the determined values and types of the environmental attributes of the first physical commodity may be selected from a number of types that are organized based on an ontology of types of physical commodities (e.g., oil, gas, corn, soy, grain, livestock, etc.), environmental attributes (e.g., carbon content, water usage, methane content, etc.), and environmental claims (e.g., carbon neutrality, greenhouse gas emissions, waste output, pollutants output, hazardous waste output, etc.).

In some cases, with respect to step 304, the digital asset generation system 102 may determine, based on the determined values and types of environmental attributes of the first physical commodity, a performance type associated with the first physical commodity and a performance value for the respective performance type of the first physical commodity. As described herein, a performance type associated with a physical commodity and a performance value for the respective performance type of the physical commodity may constitute an environmental claim for a physical commodity. For example, the digital ESG asset generation system 102 (e.g., via the asset generation subsystem 114) may determine a methane gas performance value based on a carbon content environmental attribute for the first physical commodity, where the methane gas performance value is measured based on a comparison of the carbon content of the first physical commodity to a methane gas performance standard. In some cases, the digital asset generation system 102 may determine more than one performance type and value for the first physical commodity. In some cases, determining the performance value and type may include inputting the determined environmental attributes and values for the first physical commodity into one or more smart contracts (e.g., described with respect to step 308), where the one or more smart contracts can validate determined values of the environmental attributes to determine the performance value in accordance with one or more third-party performance standards, frameworks, and/or methodologies using one or more empirical and/or correlating algorithms. In some embodiments, the measured value of the performance type for the first physical commodity may be included in a correlated digital asset associated with (e.g., linked to) a first digital asset (e.g., primary digital ESG asset) for the first physical commodity. The digital asset generation system 102 may generate (e.g., using the generation subsystem 114) a correlated digital asset including the performance value for the first physical commodity using a smart contract and one or more environmental attributes of the first physical commodity as described herein (e.g., with respect to step 308). For example, the digital asset generation system 102 may generate a correlated digital asset associated with the first physical commodity indicating the performance value and type of the first physical commodity. In some cases, the performance type and value for the first physical commodity derived from values of the environmental attributes may be compared to a respective performance type and value derived from the first plurality of attributes, thereby providing a comparison between unrefined and refined (e.g., verified) performance values for the same physical commodity.

At step 306, the digital asset generation system 102 may identify (e.g., via the asset generation subsystem 114), based on the type of the first physical commodity and/or types of the environmental attributes of the first physical commodity, a first smart contract for refining and generating digital ESG assets including indications of the environmental attributes of the first physical commodity. For example, the system may store locally or remotely (e.g., on the server system 106) a multitude of smart contracts for a multitude of different types of physical commodities and types of environmental attributes. The smart contracts may be organized based on the ontology of physical commodities, environmental attributes, and environmental claims described herein. Thus, the digital asset generation system 102 may identify the first smart contract corresponding to the type of the first physical commodity, the environmental attributes of the first physical commodity, and/or the performance or numeric values of the environmental attributes. In some cases, the first smart contract may correspond to the performance value and type for the first physical commodity.

At step 308, the digital asset generation system 102 may input the first plurality of attributes identifying the first physical commodity and/or the environmental attributes of the first physical commodity into the first smart contract (e.g., identified in step 306) to generate a first digital asset (e.g., primary digital ESG asset). For example, the first smart contract may generate, based on the first plurality of attributes of the first physical commodity, (i) an NFT, or (ii) a standardized set of data components, where the generated token or set of data components includes the refined data payload including the environmental attributes of the first physical commodity. In some embodiments, the generated first digital asset (e.g., primary digital ESG asset) may encode the first plurality of and/or the environmental attributes of the first physical commodity as encrypted or non-encrypted data within the first digital asset. The refined data payload for the first physical commodity that is included in the first digital asset may be referred to as parameters or parameter data as described herein. In some cases, a unique ID (e.g., unique string ID) may be added to the refined data payload and included in the parameter data of the first digital asset that uniquely identifies the first physical commodity. In some cases, the first plurality of attributes of the first physical commodity may be included in the refined data payload and included in the first digital asset. In some embodiments, the first smart contract may (i) receive the one or more environmental attributes of the first physical commodity and the parameter data of the first digital asset (e.g., primary digital ESG asset) and (ii) use the one or more included environmental attributes and parameter data as an input for generating a correlated digital asset associated with the first digital asset. For example, the first smart contract may generate a correlated digital asset (e.g., an NFT) indicating the environmental attributes and the performance value and type of the first physical commodity, thereby linking or correlating the values the environmental attributes and the performance value and type included in the correlated digital asset to the first plurality of attributes of the first digital asset (e.g., primary digital ESG asset). In some cases, the correlated digital asset may include an indicator linking the correlated digital asset to the first digital asset. For example, the correlated digital asset may include the unique ID included in the primary digital ESG asset, such that the correlated digital asset verifies an environmental performance standard associated with the first physical commodity identified by the primary digital ESG asset and the included attributes. Accordingly, the correlated digital asset may encode one or more of the environmental attributes from the first digital asset (e.g., primary digital ESG asset) and the performance value and type for the first digital asset, and the one or more empirical or correlating algorithms corresponding to a performance standard that are used to determine the performance value and type based on the values of the environmental attributes.

At step 310, the digital asset generation system 102 may record (e.g., via the ledger recording subsystem 116) and/or send instructions to cause recordation of the first digital asset (e.g., primary digital ESG asset) onto a digital ledger. For example, the digital asset generation system 102 may record the primary digital ESG asset onto a blockchain network of distributed processing nodes (or other suitable and interoperable networked database) or send instructions to a blockchain network of distributed processing nodes to cause recordation of the primary digital ESG asset on the blockchain network. In some cases, the digital asset generation system 102 may record (e.g., via the ledger recording subsystem 116) and/or send instructions to cause recordation of the correlated digital asset associated with the first digital asset onto a digital ledger. For example, the digital asset generation system 102 may record the correlated digital asset onto a blockchain network of distributed processing nodes or send instructions to a blockchain network of distributed processing nodes to cause recordation of the correlated digital asset onto the blockchain network.

In some embodiments, the recordings of the first digital asset and the correlated digital asset on the digital ledger may enable a user of the digital ledger to trace the origins of the correlated digital asset through a “proof of state” audit function based on control logic to map the entire lifecycle of the first digital asset (e.g., primary digital ESG asset) back to original source data (e.g., the first plurality of attributes identifying the first physical commodity). As an example, the recordings may enable a user to identify the correlated digital asset and its included attributes and use such attributes to verify the performance value and type of the first physical commodity as indicated by the first digital asset. As another example, the recordings may enable tracking of the performance value for the first digital asset associated with the first physical commodity within a marketplace and/or digital registries. In some cases, the recordings may enable a user to retire the first digital asset (e.g., primary digital ESG asset) and/or the correlated digital asset from use in a marketplace and/or digital registries based on allowing traceable identification of the performance value indicated by the correlated digital asset.

In some embodiments, the method 300 may be executed to generate additional digital assets based on the first digital asset and digital assets generated therefrom. Digital assets generated and recorded on an electronic digital ledger via execution of the method 300 may be custodied, managed, transacted, and/or retired across an interoperable network of qualifying digital registries. In some cases, more than two digital assets may be linked via execution of the method 300, thereby enabling environmental claim registration and “proof of state” data authentication through multiple digital assets back to source information.

FIG. 4 is a diagram that illustrates an exemplary computing system 400 in accordance with embodiments of the present technique. Various portions of systems and methods described herein may include or be executed on one or more computer systems similar to computing system 400. Further, processes and modules described herein may be executed by one or more processing systems similar to that of computing system 400. Operations described with respect to FIG. 2 and FIG. 3 may be performed by components of FIG. 4.

Computing system 400 may include one or more processors (e.g., processors 410a-410n) coupled to system memory 420, an input/output (I/O) device interface 430, and a network interface 440 via an I/O interface 450. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 400. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 420). Computing system 400 may be a units-processor system including one processor (e.g., processor 410a), or a multi-processor system including any number of suitable processors (e.g., 410a-410n). Multiple processors may be employed to provide for parallel or sequential execution of one or more portions of the techniques described herein. Processes, such as control logic for data flow and audit chain, environmental attribute measurement or data inputs, as well as process logic flows, described herein may be performed by one or more programmable processors executing one or more computer programs to perform functions by operating on input data and generating corresponding output. Processes described herein may be performed by, and an apparatus can also be implemented as, special purpose logic circuitry, for example, an FPGA (field programmable gate array) or an ASIC (application specific integrated circuit). Computing system 400 may include a plurality of computing devices (e.g., distributed computer systems) to implement various processing functions.

I/O device interface 430 may provide an interface for connection of one or more I/O devices 460 to computing system 400. I/O devices may include devices that receive input (e.g., from a user) or output information (e.g., to a user). I/O devices 460 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 460 may be connected to computing system 400 through a wired or wireless connection. I/O devices 460 may be connected to computing system 400 from a remote location. I/O devices 460 located on a remote computer system, for example, may be connected to computing system 400 via a network and network interface 440.

Network interface 440 may include a network adapter that provides for connection of computing system 400 to a network. Network interface 440 may facilitate data exchange between computing system 400 and other devices connected to the network. Network interface 440 may support wired or wireless communication. The network may include an electronic communication network, such as the Internet, a local area network (LAN), a wide area network (WAN), a cellular communications network, or the like.

System memory 420 may be configured to store program instructions 470 or data 480. Program instructions 470 may be executable by a processor (e.g., one or more of processors 410a-410n) to implement one or more embodiments of the present techniques. Instructions 470 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 420 may include a tangible program carrier having program instructions stored thereon. A tangible program carrier may include a non-transitory computer readable storage medium. A non-transitory computer readable storage medium may include a machine readable storage device, a machine readable storage substrate, a memory device, or any combination thereof. A non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 420 may include a non-transitory computer readable storage medium that may have program instructions stored thereon that are executable by a computer processor (e.g., one or more of processors 410a-410n) to cause the subject matter and the functional operations described herein. A memory (e.g., system memory 420) may include a single memory device and/or a plurality of memory devices (e.g., distributed memory devices).

I/O interface 450 may be configured to coordinate U/O traffic between processors 410a-410n, system memory 420, network interface 440, U/O devices 460, and/or other peripheral devices. I/O interface 450 may perform protocol, timing, or other data transformations to convert data signals from one component (e.g., system memory 420) into a format suitable for use by another component (e.g., processors 410a-410n). U/O interface 450 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 400 or multiple computer systems 400 configured to host different portions or instances of embodiments. Multiple computer systems 400 may provide for parallel or sequential processing/execution of one or more portions of the techniques described herein.

Those skilled in the art will appreciate that computing system 400 is merely illustrative and is not intended to limit the scope of the techniques described herein. Computing system 400 may include any combination of devices or software that may perform or otherwise provide for the performance of the techniques described herein. For example, computing system 400 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a global positioning system (GPS), or the like. Computing system 400 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computing system 400 may be transmitted to computing system 400 via transmission media or signals, such as electrical, electromagnetic, or digital signals, conveyed via a communication medium, such as a network or a wireless link. Various embodiments may further include receiving, sending, or storing instructions or data implemented in accordance with the foregoing description upon a computer-accessible medium. Accordingly, the present disclosure may be practiced with other computer system configurations.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A system for generating digital assets corresponding to physical commodities, the system comprising:
one or more computing systems programmed to perform operations comprising:
receiving a first plurality of attributes identifying a first physical commodity;
determining, based on the first plurality of attributes, one or more environmental attributes of the first physical commodity;
determining, based on at least one of the one or more environmental attributes, a performance type for the first physical commodity and a performance value for the performance type, wherein the performance type is selected from a plurality of performance types;
identifying, based on a type of the first physical commodity and the one or more environmental attributes, one or more smart contracts configured to (i) generate a first digital asset identifying the first physical commodity, and (ii) generate a correlated digital asset associated with the first digital asset, wherein the one or more smart contracts are selected from a plurality of smart contracts;
providing the first plurality of attributes identifying the first physical commodity and the one or more environmental attributes to the one or more smart contracts to generate the first digital asset, wherein the first digital asset comprises (i) a unique identifier for the first physical commodity, (ii) the first plurality of attributes, and (iii) the one or more environmental attributes;
providing the first plurality of attributes identifying the first physical commodity and an indication of the first digital asset to the one or more smart contracts to generate the correlated digital asset, wherein the correlated digital asset comprises (i) an indicator of an association of the correlated digital asset to the first digital asset, (ii) the performance type for the first physical commodity, and (iii) the performance value for the performance type; and
causing recordation of the first digital asset and the correlated digital asset on a digital ledger.

2. The system of claim 1, wherein the first plurality of attributes are derived from production of the first physical commodity.

3. The system of claim 1, wherein the first physical commodity comprises one of: oil, natural gas, corn, or soy.

4. The system of claim 1, wherein the one or more environmental attributes of the first physical commodity comprises one or more of: carbon content, water usage, or methane content.

5. The system of claim 1, wherein the determining the one or more environmental attributes further comprises:
providing the first plurality of attributes to the one or more smart contracts, wherein the one or more smart contracts are configured to determine the one or more environmental attributes from the first plurality of attributes.

6. The system of claim 1, wherein the determining the performance type for the first physical commodity and the performance value for the performance type further comprises:
providing the at least one of the one or more environmental attributes to the one or more smart contracts, wherein the one or more smart contracts are configured to measure the performance value for the performance type based on comparing a value of the at least one of the one or more environmental attributes to an environmental performance standard or methodology comprising one or more algorithms.

7. The system of claim 1, wherein the performance type of the first physical commodity comprises one of: a carbon content intensity or a natural gas intensity.

8. The system of claim 1, wherein an environmental claim for the first physical commodity comprises (i) the performance type for the first physical commodity and (ii) the performance value for the performance type.

9. The system of claim 8, wherein the environmental claim for the first physical commodity is correlated to the at least one of the one or more environmental attributes by one or more algorithms, wherein the correlated digital asset comprises an indication of the one or more algorithms.

10. The system of claim 1, wherein the first digital asset and the correlated digital asset each comprise a non-fungible token.

11. The system of claim 1, wherein the operations further comprise:
receiving a second plurality of attributes identifying a second physical commodity, wherein the second physical commodity is dependent on the first physical commodity;
identifying one or more second smart contracts configured to generate a second digital asset identifying the second physical commodity, wherein the one or more second smart contracts are selected from the plurality of smart contracts;
providing the second plurality of attributes identifying the second physical commodity and the indication of the first digital asset to the one or more second smart contracts to generate the second digital asset, wherein the second digital asset comprises an indicator of an association of the second digital asset to the first digital asset and the second plurality of attributes; and
causing recordation of the second digital asset on the digital ledger.

12. The system of claim 11, wherein the operations further comprise:
determining, based on the second plurality of attributes, one or more second environmental attributes of the second physical commodity, wherein the second digital asset comprises the one or more second environmental attributes.

13. The system of claim 11, wherein the operations further comprise:
causing recordation of a digital marking on the digital ledger, wherein the digital marking indicates an association between the first digital asset and the second digital asset.

14. The system of claim 13, wherein the digital marking is configured to require a first digital wallet address to own both the first digital asset and the second digital asset.

15. The system of claim 13, wherein the digital marking is configured to require bundled transfer of the first digital asset and the second digital asset from a first digital wallet address to a second digital wallet address.

16. The system of claim 11, wherein the second physical commodity being dependent on the first physical commodity further comprises the second physical commodity being derived from the first physical commodity.

17. The system of claim 1, wherein the digital ledger is implemented as a network of decentralized independent processing nodes.

18. A method for generating digital assets corresponding to physical commodities, the method comprising:
receiving a first plurality of attributes identifying a first physical commodity;
determining, based on the first plurality of attributes, one or more environmental attributes of the first physical commodity;
determining, based on at least one of the one or more environmental attributes, a performance type for the first physical commodity and a performance value for the performance type, wherein the performance type is selected from a plurality of performance types;
identifying, based on a type of the first physical commodity and the one or more environmental attributes, one or more smart contracts configured to (i) generate a first digital asset identifying the first physical commodity, and (ii) generate a correlated digital asset associated with the first digital asset, wherein the one or more smart contracts are selected from a plurality of smart contracts;
providing the first plurality of attributes identifying the first physical commodity and the one or more environmental attributes to the one or more smart contracts to generate the first digital asset, wherein the first digital asset comprises (i) a unique identifier for the first physical commodity, (ii) the first plurality of attributes, and (iii) the one or more environmental attributes;
providing the first plurality of attributes identifying the first physical commodity and an indication of the first digital asset to the one or more smart contracts to generate the correlated digital asset, wherein the correlated digital asset comprises (i) an indicator of an association of the correlated digital asset to the first digital asset, (ii) the performance type for the first physical commodity, and (iii) the performance value for the performance type; and
causing recordation of the first digital asset and the correlated digital asset on a digital ledger.

19. The method of claim 18, wherein the first plurality of attributes are derived from production of the first physical commodity.

20. The method of claim 18, wherein the first physical commodity comprises one of: oil, natural gas, corn, or soy, and wherein the digital ledger is implemented as a network of decentralized independent processing nodes.
